(19) United States
(12) Patent Application Publication
(10) Pub. No.: US 2026/0260772 A1
(43) Pub. Date: Sep. 3, 2026

(54) SYSTEM FOR THE PRODUCTION OF A RADIOISOTOPE

(71) Applicant: COMECER S.P.A., Castel Bolognese (IT)

(72) Inventors: Alessandro BRUNETTI, Castel Bolognese (IT); Marco TESTA, Castel Bolognese (IT); Flippo GALASSI, Castel Bolognese (IT)

(21) Appl. No.: 19/158,107

(22) PCT Filed: Feb. 19, 2024
(86) PCT No.: PCT/IB2024/051572

§ 371 Date: Aug. 20, 2025

(30) Foreign Application Priority Data
Feb. 24, 2023 (IT) 102023000003309

(51) Int. Cl. G21G 1/10; G21F 5/015

(52) U.S. Cl. CPC G21G 1/10; G21F 5/015

(57) ABSTRACT

A system for the production of a radioisotope comprising a container with a planar face on which a portion of solid target material is present having an elliptical shape, an irradiation station for emitting a proton beam against the solid target material portion and a transfer system for transferring the container to the irradiation station having an annular seat for receiving the container from the planar face side and is oriented such that a section of the proton beam along an annular seat plane is elliptical. The transfer system comprises a housing, a rotation assembly for rotating the container within the housing to orient the elliptical shape of the solid target material portion as the elliptical shape of the proton beam section, and a handling assembly for grasping the container from opposite the planar face side and transferring it from the housing to the annular seat.

### CROSS-REFERENCE TO RELATED APPLICATIONS

This Patent Application claims priority from Italian Patent Application No. 102023000003309 filed on Feb. 24, 2023, the entire disclosure of which is incorporated herein by reference.

### TECHNICAL FIELD

This invention relates to a system for the production of a radioisotope using a solid target material.

In particular, this invention finds advantageous, but not exclusive, application in the production of a radioisotope using a low-or medium-energy cyclotron, i.e. a cyclotron with energy below or equal to 18 MeV, starting from a solid precursor material, otherwise known as solid target material, electrodeposited on a suitable metallic support, to which the description that follows will explicitly refer without any loss of generality thereby.

### BACKGROUND

Today, various types of radioisotopes for pharmaceutical use (radiopharmaceuticals) are formed as a result of irradiation using a proton beam (proton bombardment) of a solid target material typically of metallic origin.

The production process of a radioisotope using a solid target material basically involves the following steps: electrodeposition (“electroplating”) of the solid target material on a metallic support; irradiation using a proton beam of the solid target material on the support; dissolving the irradiated solid target material to obtain a solution in which there is the radioisotope produced by the proton irradiation; and purifying the above-mentioned solution to separate the radioisotope from the target material that has not reacted and from impurities. The above-mentioned steps are carried out in corresponding processing stations and, thus, the support comprising the solid target material must be arranged inside a container for transport between several processing stations, for example from the electrodeposition station to the irradiation station and from the irradiation station to the dissolving station.

Systems for producing a radioisotope are known that comprise an electrodeposition station, an irradiation station, a dissolving station, a purification station, and an automatic transport station for transport, between some of the above-mentioned stations, of the container that contains the support with the solid target material still to be irradiated or already irradiated. For this reason, this container is also known as a “shuttle”.

The irradiation station comprises a cyclotron for emitting the proton beam against the solid target material and a liquid cooling system that is connected to the support for the related cooling during proton bombardment. In addition, there are known supports designed to be placed directly in the dissolving station and able to resist agents that produce the solution with the radioisotope.

The efficiency of radioisotope production strongly depends on the extension of the layer of solid target material that is irradiated by the proton beam and, thus, by the cross-section of the proton beam. In fact, the thickness of the layer of solid target material must not exceed an optimal value, beyond which the average energy transferred by the proton beam would not be absorbed by all the solid target material and, thus, there would be a drop in productivity of the radioisotope.

Typically, the support with the solid target material is positioned coaxially opposite the cyclotron coaxially to the proton beam and, for the sake of production efficiency, the layer of solid target material must have a circular shape, coaxial to the support and having a diameter corresponding to that of the proton beam section. In any case, the circular shape of the portion of solid target material electrodeposited on the support, with the same proton beam section, proton beam energy, and thickness of the solid target material, limits the quantity of solid target material that can actually be deposited on the support and, as a result, maximum productivity.

In addition, the known containers for the production of radioisotopes are not hermetic and, therefore, cannot be used to contain some solid precursor materials, such as, for example, radioactive metals. For example, the metal 226-Ra is radioactive and spontaneously releases, via alpha decay, the gas 222-Rn, which is also radioactive.

### SUMMARY

The purpose of this invention is to provide a system for the production of a radioisotope, which is free of the drawbacks described above and, at the same time, is easy and economical to produce.

In accordance with this invention, a system for the production of a radioisotope is provided as defined in the appended claims.

The claims describe preferred embodiments of this invention to be considered an integral part of this description.

### BRIEF DESCRIPTION OF THE DRAWINGS

This invention will now be described with reference to the attached drawings that illustrate a non-limiting embodiment thereof, in which:

FIG. 1 illustrates an exploded axonometric view of a container for a system for the production of a radioisotope produced according to this invention;

FIG. 2 illustrates the container in FIG. 1 according to a cross-section view along a plane on which the longitudinal axis of the container 1 lies;

FIG. 3 illustrates the container in FIG. 1 according to a cross-section view along another plane on which the longitudinal axis orthogonal to the cross-section plane in FIG. 2 lies;

FIG. 4 illustrates a component of the container in FIG. 1 according to an axonometric view wherein some internal features of the component are highlighted, using dashed lines;

FIG. 5 illustrates the component in FIG. 4 during an irradiation step of a portion of the solid target material on one face of the component;

FIG. 6 illustrates, according to a longitudinal cross-section view, the system for the production of a radioisotope of this invention during a particular operation step;

FIG. 7 illustrates a perspective view of a component of the system in FIG. 6;

FIG. 8 illustrates a perspective view of a part of the system in FIG. 6;

FIG. 9 illustrates a cross-section view of the part of the system in FIG. 7; and

FIGS. 10 to 13 illustrate, according to the same longitudinal cross-section view, the system in FIG. 6 during as many operation steps.

### DESCRIPTION OF EMBODIMENTS

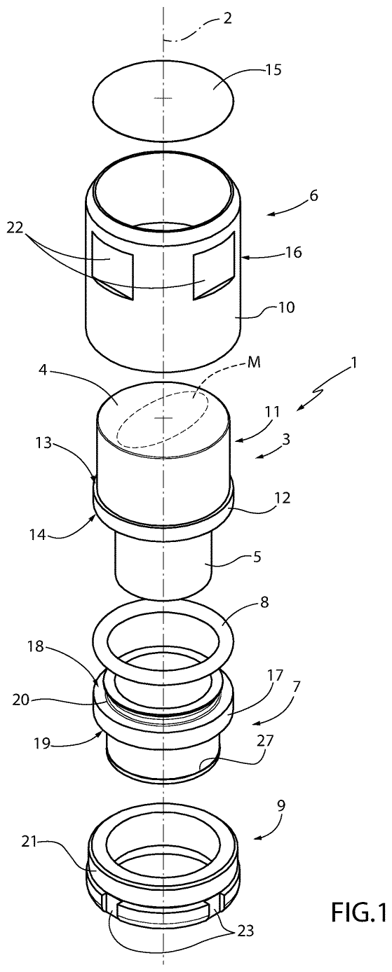

In FIG. 1, reference number 1 generically identifies, as a whole, the container of this invention suitable for containing a solid target material and a radioisotope produced using irradiation with a proton beam of the solid target material. The container 1 extends according to its own longitudinal axis 2 and comprises a support body 3 for the solid target material, which extends along the longitudinal axis 2 and comprises a planar face 4, which is transverse and, in particular, orthogonal to the longitudinal axis 2, and on which a portion of solid target material is electrodeposited, illustrated with a dashed line and identified with M in FIG. 1, and a cup cap 6, which is designed to coaxially cover the support body 3.

In addition, the support body 3 comprises a neck 5 extending from the part axially opposite the face 4 and the container 1 comprises a spacer ring 7, which is fitted on the neck 5, in particular without interference, a hermetic seal ring 8, which is fitted on the spacer ring 7, and a ring nut 9, which is fitted on the spacer ring 7 and couples with an end portion 10 of the cup cap 5 so as to bellow close the container 1.

The support body 3 has an external shape with cylindrical symmetry in relation to the longitudinal axis 2. In particular, the support body 3 comprises a cylindrical portion 11 having a first longitudinal end that is defined by the face 4. In other words, the face 4 is defined by a circular end base of the cylindrical portion 11. The neck 5 extends from a second longitudinal end of the cylindrical portion 11, i.e. from one side of the cylindrical portion 11 axially opposite the face 4, coaxially to the cylindrical portion 11 itself. The neck 5 has a smaller diameter than that of the cylindrical portion 11. On the side axially opposite the face 4, the cylindrical portion 11 ends with a rib 12 protruding outside that defines two shoulders 13 and 14 opposite each other.

The support body 3 is made of aluminium. The cylindrical portion 11, excluding the rib 12, is covered by a thin layer of coating material, which is suitable for electrodeposition of the solid target material M and is inert to the acids that are used to dissolve the solid target material after it has been irradiated by the proton beam. In fact, aluminium is a light material that is easy to process to obtain components with the desired shapes, but it dissolves in the acids used during the dissolving step of the process for producing the radioisotope.

The coating material is made integral with the support body 3 using braze-welding. The coating material is preferably platinum. The coating material has a thickness of less than 200 μm, and, in particular, equal to 100 μm.

The cup cap 6 comprises a bottom 15 that can be crossed by a proton beam. In other words, the bottom 15 offers the proton beam negligible attenuation.

In particular, the cup cap 6 comprises a cylindrical, metal body 16, which has a first longitudinal end closed by the bottom 15 and a second, open longitudinal end that can be engaged by the support body 3. Thus, the bottom 15 has a circular shape. The bottom 15 is a metal sheet, preferably having a thickness less than 100 μm and, in particular, equal to 50 μm. The end portion 10 is defined at the second longitudinal end of the cylindrical body 16.

The cup cap 6 is made of aluminium. In particular, the cylindrical body 16 and the bottom 15 are made of aluminium. The bottom 15 is joined to the cylindrical body 16 via laser microwelding along an annular edge of the cylindrical body 16.

The spacer ring 7 comprises a rib 17 protruding outside that defines two shoulders 18 and 19 opposite each other. The shoulder 18 faces the other shoulder 14 of the cylindrical portion 11 of the support body 3. The spacer ring 7 also comprises a groove 20 arranged adjacent to the shoulder 18 and acting as a seat for the hermetic seal ring 8. The hermetic seal ring 8 is a common O-ring arranged between the shoulder 14 of the support body 3 and the shoulder 18 of the spacer ring 7.

The end portion 10 of the cup cap 6 is threaded on the inside and the ring nut 9 has an externally threaded portion 21 to screw into the end portion 10.

The spacer ring 7 and the ring nut 9 are both made of aluminium.

The cup cap 6 comprises multiple external cuts 22 and, like the ring nut 9, comprises multiple external cuts 23 to facilitate being gripped by the fingers of an operator during the bellows closure of the container 1 and/or to enable releasable mechanical coupling with support means of a system for producing a radioisotope, not illustrated in FIGS. 1 to 4.

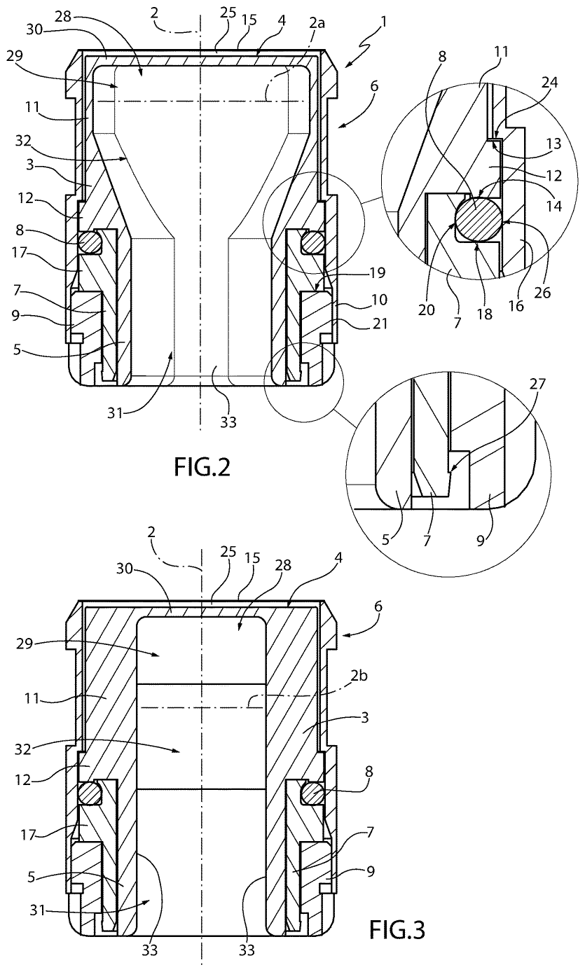

With reference to FIGS. 2 and 3, which illustrate the container 1 according to two respective cross-section views along two planes orthogonal to each other at the longitudinal axis 2, the face 4 and the bottom 15 are transverse to the longitudinal axis 2 and, in particular, are parallel to each other. The bottom 15 covers the whole face 4.

The shoulder 13 of the support body 3 rests on an inner shoulder 24 of the cup cap 6, and, in particular, of the cylindrical body 16, so as to define a gap 25 between the face 4 and the bottom 15 that is designed to contain the portion of solid target material M (not illustrated in FIGS. 2 and 3) electrodeposited on the face 4 and the radioisotope produced after irradiation with a proton beam of the portion of solid target material.

The gap 25 is very thin, i.e. its thickness is much less than the diameter of the face 4. In particular, the ratio between the thickness of the gap 25 and the diameter of the face 4 ranges between 0.03 and 0.05. The thickness of the gap 25 is basically constant.

The shoulders 13 and 24 are better illustrated in an enlarged detail of FIG. 2.

The external threaded portion 21 of the ring nut 9 can be screwed to the end portion 10 of the cup cap 6 until the ring nut abuts the shoulder 19, as illustrated in FIGS. 2 and 3. Thanks to the interference-free coupling between the neck 5 and the spacer ring 7, the screwing of the ring nut 9 to the end portion 10 pushes the spacer ring 7 along the longitudinal axis 2 until it abuts the shoulder 14 of the support body 3. This creates the bellows closure of the container 1.

The bellows closure of the container 1 ensures that the hermetic seal ring 8 contacts, in addition to the shoulder 18 of the spacer ring 7, the shoulder 14 of the support body 3 too and an inner side surface 26 of the cup cap 6, and, in particular, the cylindrical body 16. In this way, an overall gap, which comprises the gap 25, between the support body 3 and the cup cap 6, and, in particular, between the cylindrical portion 11 of the support body 3 and an inner portion of the cup cap 6 that extends from the bottom 15 to the shoulder 24, is hermetically sealed. At the same time, the support body 3 can rotate in relation to the cup cap 6 around the longitudinal axis 2 so as to be able to orient the portion of solid target material M present on the face 4 in relation to a proton beam that is projected from the outside on the bottom 15 of the cup cap 6.

The spacer ring 7 comprises an annular tooth 27 protruding from its external surface to axially hold the ring nut 9 on the spacer ring 7 once the ring nut 9 has been fitted to the spacer ring 7. The annular tooth 27 can be seen in FIGS. 1, 2, and 3 and is better illustrated in an enlarged detail of FIG. 2.

Therefore, the ring nut 9, when it is fitted on the spacer ring 7 during the assembly of the container 1, is subject to a certain interference to move beyond the annular tooth 27.

The support body 3 internally comprises a cavity 28, which comprises a first volume 29 localised in the cylindrical portion 11 and extending diametrically below the face 4, and, in particular, parallel to the face 4, as can be seen in FIG. 2. In other words, the support body 3 comprises a flat wall 30 transverse and, in particular, orthogonal to the longitudinal axis 2 and this flat wall 30 has the face 4 outside the support body 3 and delimits, in part, the volume 29 inside the support body 3. In particular, the volume 29 mainly extends along a direction 2a (FIG. 2) perpendicular to the longitudinal axis 2 (and, thus, parallel to the face 4), i.e. the volume 29 has a greater dimension along that direction 2a.

The cavity 28 comprises a second volume 31, which extends inside the neck 5 for the whole length of the latter to define an access conduit for a cooling fluid that communicates with the first volume 29 with the purpose of cooling the support body 3 during the irradiation of the solid target material. Hereinafter, the feature identified by the reference number 31 will be called second volume or access conduit depending on the particular context.

Thus, more generally, the support body 3 comprises a first longitudinal end defined by the face 4, a second longitudinal end axially opposite the face 4 defined by the open end of the neck 5, and the cavity 28 that can be accessed through the access conduit 31, which is open at the second, longitudinal end to enable the circulation of a cooling liquid in the cavity 28 during the irradiation of the solid target material.

The cavity 28 comprises a third volume 32, which places the first volume 29 in communication with the second volume 31 and is tapered from the first volume 29 to the second volume 31 except for in relation to a certain direction 2b (FIG. 3) orthogonal to the longitudinal axis 2. The direction 2b is preferably orthogonal to the direction 2a.

The total volume of the cavity 28 is defined, in relation to the direction 2b, between two flat inner surfaces 33 of the support body 3, which are parallel to each other and to the longitudinal axis 2 and extend from the first volume 29 to the second volume 31.

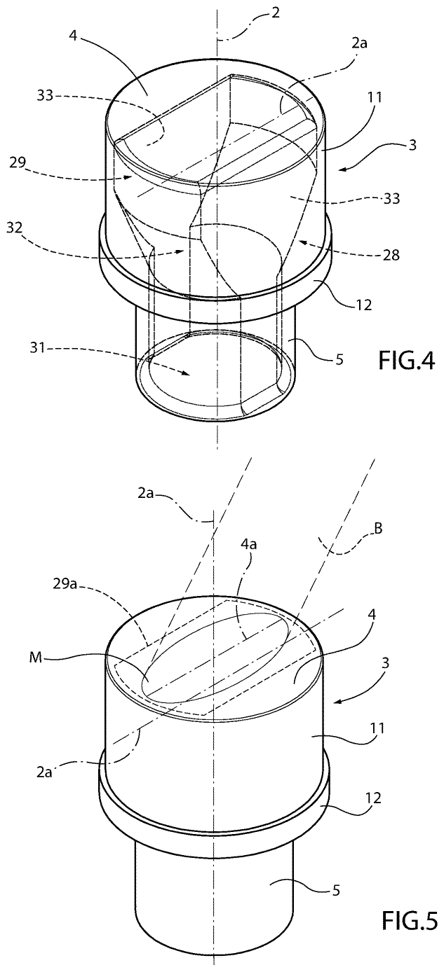

FIG. 4 illustrates an axonometric view of just the support body 3 wherein the cavity 28 is drawn with a dashed line, to better show all its parts, such as the volumes 29, 31, and 32 and the flat inner surfaces 33. FIG. 4 also includes the reference numbers that identify the parts of the support body 3 described above.

The production of the radioisotope follows a method that comprises the steps of electrodepositing a portion of the solid target material M on the face 4 and, following this, irradiating the portion of solid target material M with the proton beam. The irradiation of the portion of solid material M takes place with the container 1 closed; thus, the proton beam reaches the face 4 after crossing the bottom 15.

FIG. 5 illustrates the support body 3 in FIG. 4 after the electrodeposition of the portion of target material M and, in particular, during irradiation with the proton beam B. The proton beam B is obliquely directed on the face 4 so that the beam section along the face 4 has an elliptical shape. In fact, the proton beam B typically has an orthogonal section with a circular shape. In addition, the portion of target material M is electrodeposited so as to give it an elliptical shape that is basically equal to that of the beam section and the support body 3 is oriented so that the beam section precisely overlaps the portion of solid target material M.

The portion of solid target material M is electrodeposited on the face 4 so as to remain inside an area 29a of the face 4 defined by a projection of the volume 29 on the plane of the face 4 according to the longitudinal axis 2. This makes it possible to maximise the cooling of the portion of solid target material M during the irradiation step.

The portion of solid target material M is electrodeposited so that its elliptical shape has a predetermined angular position in relation to a transverse shape of the access conduit 31. In particular, the portion of solid target material M is electrodeposited so that its elliptical shape is centred on the longitudinal axis 2 and has a larger axis 4a parallel to the direction 2a, as shown in FIG. 5. In other words, the larger axis of the elliptical shape of the portion of solid target material M is arranged parallel to the flat inner surfaces 33 (FIG. 4). The flat inner surfaces 33 are visible from the access conduit 31 of the neck 5 of the support body 3. In this way, it is possible to identify the axial position of the portion of solid target material M and, thus, correctly orient the support body 3 in relation to the proton beam B, including with the closed container 1.

The elliptical shape of the portion of solid target material M makes it possible to increase the quantity of solid target undergoing irradiation, with the same thickness of the portion of solid target material M, and thus, to increase the quantity of radioisotope produced with the same energy of cyclotron that generates the proton beam B and the same proton beam B orthogonal section. In fact, the thickness of the portion of solid target material M must remain within a given range of values; otherwise, the bombardment of protons would produce many more impurities in addition to the desired radioisotope.

The oblique irradiation of the whole portion of solid target material M through the cup cap 6 is enabled by the fact that the latter and the support body 3 basically do not place obstacles in the way of the oblique proton beam B thanks to the face 4 that extends along the whole first longitudinal end of the cylindrical portion 11 and, similarly, to the bottom 15 that extends along the whole first longitudinal end of the cylindrical body 16.

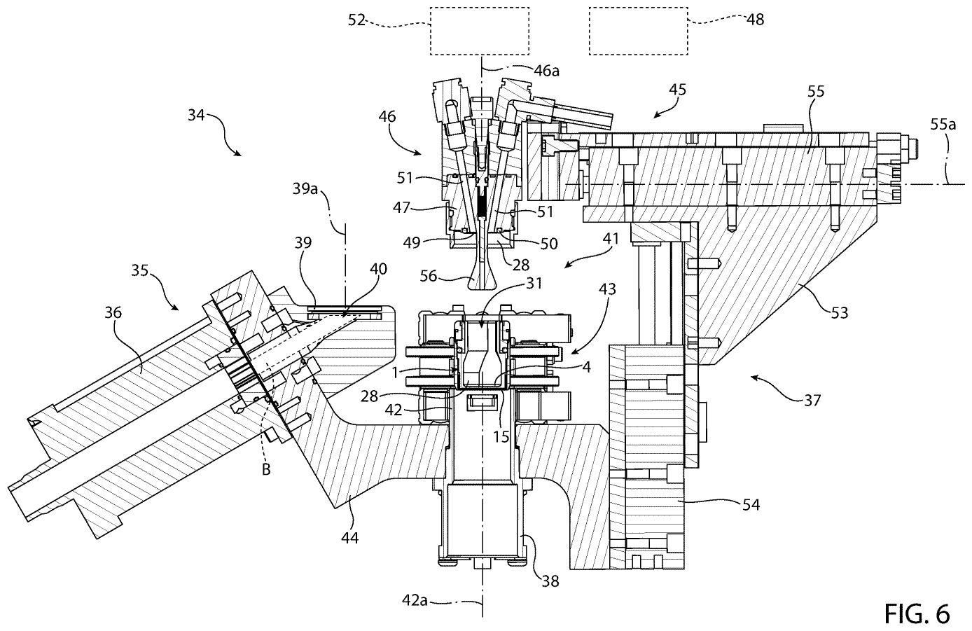

In FIG. 6, reference number 34 generically identifies, as a whole, a system for producing a radioisotope, which comprises, in addition to the container 1, an irradiation station 35, which comprises a cyclotron 36 to emit a proton beam B against the portion of solid target material M in the container 1, and a transfer system 37 for transferring the container 1 to the irradiation station 35. FIG. 6 illustrates the system for producing a radioisotope 34 according to a cross-section view along a longitudinal plane on which the emission axis of the proton beam B lies.

The system for producing a radioisotope 34 typically comprises other processing stations (not illustrated), such as an electrodeposition station, wherein the portion of solid target material M is electrodeposited on the face 4 of the support body 3, and a dissolving station, wherein the irradiated solid target material is dissolved to obtain a solution wherein there is the radioisotope produced by the proton irradiation. The transfer system 37 has a conduit 38, which can be connected to a known pneumatic transfer system (not illustrated) to convey the container 1 from the electrodeposition station to the transfer system 37 and, after the irradiation of the portion of solid target material M, from the transfer system 36 to the dissolving station. Typically, the pneumatic transfer system too can be part of the radioisotope 34 production system.

The irradiation station 35 comprises an annular seat 39, which is designed to coaxially receive the container 1 on the side of the face 4 of the support body 3, has an opening 40 that communicates with the cyclotron 36 to receive the proton beam B, and is oriented according to a first axis 39a oblique to the direction of the proton beam B so that a section of the proton beam B along a virtual plane of the annular seat 39 is elliptical, this section of the proton beam B being identified hereinafter with S. In particular, the annular seat 39 is designed to receive the cup cap 6 at the bottom 15. In this way, in use, the section of the proton beam B along the face 4 will have an elliptical shape corresponding to the elliptical shape of the portion of solid target material M.

In use, the container 1 comes from the electrodeposition station with the portion of solid target material M arranged with a predetermined angular position in relation to the transverse shape of the access conduit 31. In any case, the container 1 could reach the conduit 38 not correctly aligned with the section S of the proton beam B.

To overcome the above-mentioned problem, the transfer system 37 comprises an angular orientation station 41, which comprises a housing cylinder 42 to coaxially house the container 1 and a rotation assembly 43 to rotate the container 1 when it is inside the housing cylinder 42 in order to orient the elliptical shape of the portion of solid target material M like the elliptical shape of the section S of the proton beam B.

The housing cylinder 42 is integral with the annular seat 39 and extends along an axis 42a parallel to the axis 39a of the annular seat 39a. In particular, the transfer system for the radioisotope 34 comprises a support base 44 and the irradiation station 35 and the angular orientation station 41 are mounted on the support base 44 so that the axes 39a and 42a are parallel to each other and the axis 39 is oblique to the direction of the proton beam B.

The housing cylinder 42 is coaxial to the conduit 38 to receive the container 1 from the pneumatic transfer system. Advantageously, the housing cylinder 42 and the conduit 38 are part of a single, cylindrical components and the conduit 38 acts as an end portion of the housing cylinder 42 that can be connected to the pneumatic transfer system. Said cylindrical component is mounted though a hole of a flat portion of the support base 44 so that the housing cylinder 42 and the conduit 38 protrude on opposite sides of the flat portion from the support base 44.

The transfer system 37 comprises, in addition, a handling assembly 45 mounted on the support base 44 to grasp the container 1 on the opposite side, along its longitudinal axis 2 (not illustrated in FIG. 6), to that of the face 4, i.e. on the side opposite the bottom 15 one of the cup cap 6, and to transfer the container 1 from the angular orientation station 41 to the irradiation station 35, in particular from the housing cylinder 42 to the annular seat 39. To this end, the housing cylinder 42 comprises an open longitudinal end from which the container 1 projects, in use, on the side opposite the face 4 to enable the handling assembly 45 to grasp the container 1.

In particular, the handling assembly 45 comprises a gripping head 46, which can be moved in relation to the support base 44 parallel to the axis 42a and is designed to grasp the container 1 on the side opposite the face 4 when the container 1 is housed in the housing cylinder 42. To this end, the pneumatic transfer system (not illustrated) is configured to transfer the container 1 to the conduit 38 with the side opposite that of the face 4 turned towards the housing cylinder 42. Thus, the container 1 is housed in the housing cylinder 42 with the side opposite that of the face 4 facing the gripping head 46.

The gripping head 46 extends along an axis 46a and comprises a coupling portion 47 designed to coaxially close and hermetically seal the access conduit 31 of the container 1. The handling assembly 45 comprises a vacuum generator 48 connected to the coupling portion 47 to suck air from the cavity 28 of the support body 3 so that the gripping head 46 can retain the container 1. In particular, the coupling portion 47 comprises a mouth 49 arranged according to a virtual plane transverse to the axis 46a and the vacuum generator 48 is connected to the mouth 49. The mouth 49 is provided with an annular seal 50 designed to create a seal with an end edge of the access conduit 31.

The coupling portion 47 comprises two conduits 51, which open on the mouth 49 and are pneumatically connected to the vacuum generator 48. In particular, the conduits 51 are designed to be alternately connected to the vacuum generator 48 and a liquid cooling system 52 of the system for producing a radioisotope 34 depending on the latter operation step. In use, when the gripping head 46 works to grip the container 1 and transfer it between the angular orientation station 41 and the irradiation station 35, then the conduits 51 are connected to the vacuum generator 48 and when, instead, the gripping head 46 is in the irradiation station 35 to keep the container 1 in the annular seat 39, then the conduits 51 are connected to the liquid cooling system 52 to make the cooling liquid circulate in the cavity 28 in order to cool the support body 3 during irradiation.

The handling assembly 45 comprises a movable support 53, which is movable in relation to the support base 44 parallel to the axis 42a and on which the gripping head 46 is assembled, an actuator 54 fixed to the support base 44 to move the movable support 53 parallel to the axis 42a and another actuator 55 assembled on the movable support 53 to move the gripping head 46 in relation to the movable support 53 along an axis 55a orthogonal to the axis 42a, between the angular orientation station 41, i.e. in a position coaxial to the housing cylinder 42, and the irradiation station 35, i.e. in a position coaxial to the annular seat 39.

The actuators 54 and 55 are linear, pneumatic actuators.

The gripping head 46 comprises a centring element 56 designed to engage, without interference, the access conduit 31, in the direction of the longitudinal axis 2, with an at least partial transverse shape coupling, when the gripping head 46 is lowered towards the container 1, so that the gripping head 46 cooperates with the rotation assembly 43 to correctly orient the container 1 before the latter is transferred to the irradiation station 35.

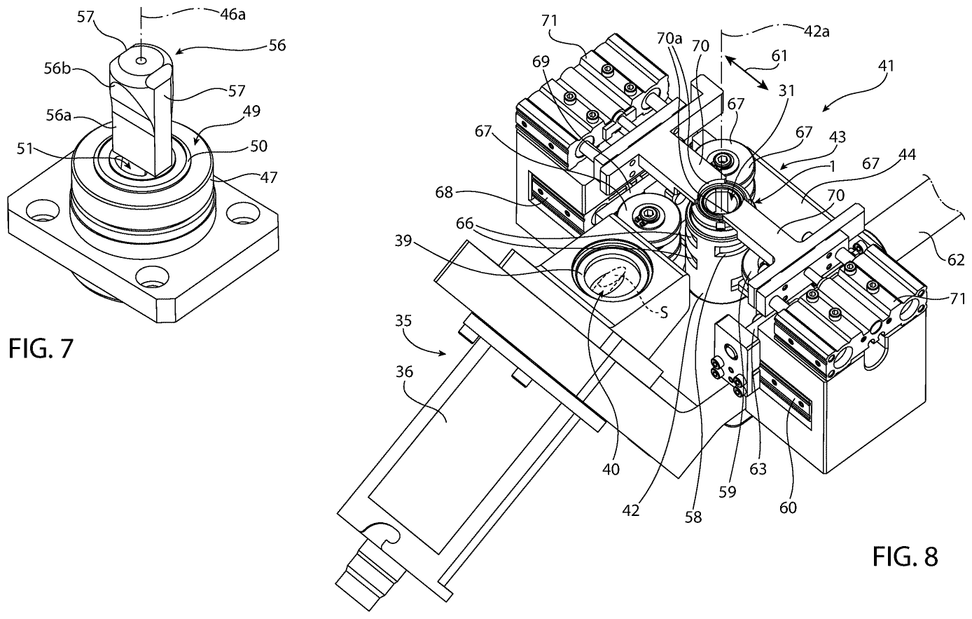

With particular reference to FIG. 7, which illustrates the coupling portion 47 facing upwards so as to enable a rapid, visual comparison with the support body 3 illustrated in FIG. 4, the centring element 56 projects coaxially from the coupling portion 47, and in particular from the mouth 49, and is designed to completely enter the cavity 28 when the mouth 49 hermetically seals the access conduit 31.

In particular, the centring element 56 has an external transverse shape so as to create an at least partially shaped coupling with the transverse shape of the access conduit 31. More specifically, the outer transverse shape of the centring element 56 is coupled with the transverse shape of the access conduit 31 at the flat inner surfaces 33 of the access conduit 31 (FIG. 4). In other words, the centring element 56 has a pair of flat outer surfaces 57 parallel to each other, each of which is designed to come into contact with a corresponding flat inner surface 33, and in particular each flat outer surface 57 slides along a respective flat inner surface 33 when the centring element 56 enters the access conduit 31.

The outer transverse shape of the centring element 56 has a predetermined angular portion in relation to the elliptical shape of the section S of the proton beam B. More specifically, the predetermined angular position of said outer transverse shape corresponds to the angular position of the elliptical shape of the portion of solid target material M in relation to the transverse shape of the access conduit 31.

In FIG. 7, the outlet of one of the two conduits 51 is also visible.

FIG. 8 illustrates the irradiation station 35 and the angular orientation station 41 according to a perspective view from above. The handling assembly 45 is not illustrated for greater clarity. FIG. 8 shows the annular seat 39 with a cylindrical shape, the opening 40 with an elliptical shape, and the section S with an elliptical shape of the proton beam B. The opening 40 has an elliptical shape since it is formed along a plane parallel to the annular seat 39, which is oblique in relation to the direction of the proton beam B.

With reference to FIG. 8, the housing cylinder 42 comprises a side slot 58 and the rotation assembly 43 comprises a drive wheel 59, an actuator 60 for translating the shaft of the drive wheel 60, in relation to the support base 44, along a direction 61 transverse to the axis 42a, to and from a working position, wherein the drive wheel 59 engages the slot 58 until it touches a side wall of the container 1, in particular the side wall (cylindrical body 16) of the cup cap 6, and an actuator 62 to drive the drive wheel 59 in order to make the container 1 rotate inside the housing cylinder 42. The slot 58 is oriented transversely to the axis 42a and the shaft of the drive wheel 59 is parallel to the axis 42a.

The actuator 60 is a linear, pneumatic actuator. The rotation assembly 43 comprises a support element 63 that is movable in relation to the support base 44 along the direction 61, the shaft of the drive wheel 59 and the actuator 62 are assembled on the support element 63 and the actuator 60 translates the support element 63 along the direction 61. The actuator 62 comprises a pneumatic motor kinematically coupled to the drive wheel 59, for example via coupling with a worm screw and gear (not visible in FIG. 8).

The housing cylinder 42 comprises at least one additional side slot 66 and the rotation assembly 43 comprises at least one corresponding idler wheel 67 and an actuator 68 for translating the shaft of the idler wheel 67, in relation to the support base 44, along the direction 61, to and from a working position, wherein the idler wheel 67 engages the slot 66 until it touches the side wall of the container 1, in particular the side wall of the cup cap 6, so as to facilitate the rotation of the container 1 in the housing cylinder 42.

In the particular example in FIG. 8, the housing cylinder 42 comprises two pairs of side slots 66 and the rotation assembly 43 comprises two respective pairs of idler wheels 67, the wheels of each pair of idler wheels 67 being assembled on the same shaft. The slots of each pair of slots 66 are parallel to each other and transverse to the axis 42a and the shafts of the pairs of idler wheels 67 are parallel to the axis 42a.

The two shafts of the two pairs of idler wheels 67 and the shaft of the drive wheel 59 are arranged at the vertices of a virtual equilateral triangle so that the idler wheels 67 press on the container 1 according to a direction opposite that of the drive wheel 59.

The actuator 68 is a linear, pneumatic actuator. The rotation assembly 43 comprises a support element 69 that is movable in relation to the support base 44 along the direction 61, the shaft of the idler wheel 67 or the shafts of the pairs of idler wheels 67 are assembled on the support element 69 and the actuator 68 translates the support element 69 along the direction 61.

The angular orientation station 41 comprises at least one upper occluder element 70 movable in relation to the support base 44 along the direction 61 at the open end of the housing cylinder 42 and a respective actuator 71 for moving the occluder element 70 to and from an end stroke position, wherein the container 1 is intercepted at the open end of the housing cylinder 42. The actuator 71 is integral with the support base 44.

The end stroke position is that illustrated in FIG. 8. In particular, each occluder element 70 has a respective end 70a shaped like a circular segment so as to intercept a corresponding edge portion of the container 1, leaving the access conduit 31 free.

In the particular example of FIG. 8, the angular orientation station 41 comprises two occluder elements 70, which are arranged in opposite positions in relation to the axis 42a and are movable in opposite directions, and two corresponding actuators 71.

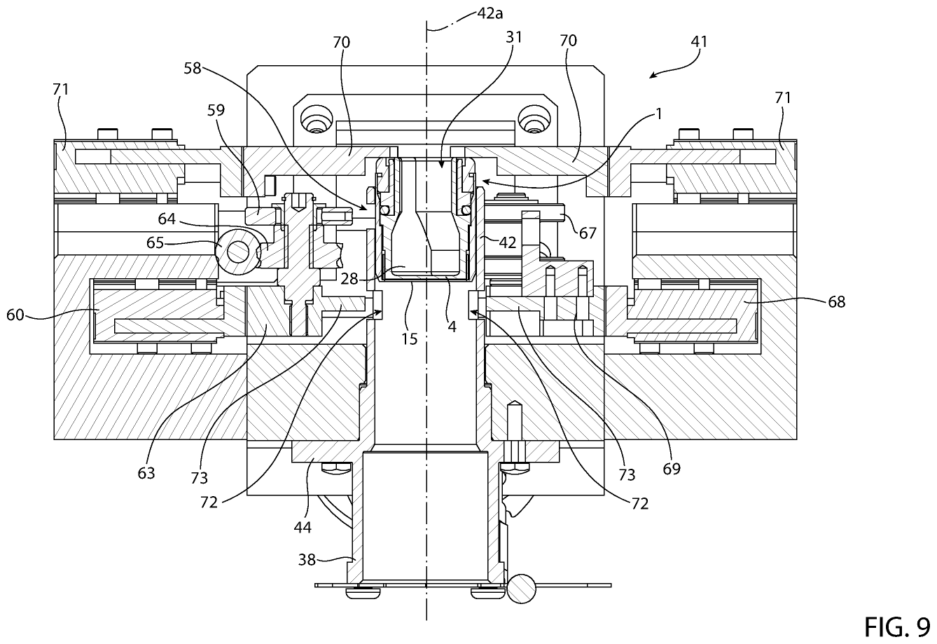

With reference to FIG. 9, which illustrates the angular orientation station 41 according to a cross-section view along a transverse plane and comprising the axis 42a, the housing cylinder 42 comprises at least one additional side slot 72 and the angular orientation station 41 comprises at least one lower occluder element 73 movable in relation to the support base 44 along the direction 61 through the slot 72 to be able to enter the housing cylinder 42 in order to prevent the container 1 from descending along the housing cylinder 42.

In the particular example of FIG. 9, the housing cylinder 42 comprises two side slots 72 formed in diametrically opposite positions in relation to the axis 42a and the angular orientation station 41 comprises two occluder elements 73, which are arranged in opposite positions in relation to the axis 42a and are movable in opposite directions to cross the corresponding slots 72.

A first occluder element 73 is formed in the support element 63. In this way, in use, when the actuator 60 translates the support element 63 towards the housing cylinder 42 to bring the drive wheel 59 into contact with the side wall of the container 1, the occluder element 73 projects into the housing cylinder 42 through the slot 72 to prevent the container 1 from descending along the housing cylinder 42 and escaping the conduit 38.

The other occluder element 73 is formed in the support element 69 and operates similarly to the first occluder element 73 when the actuator 68 translates the support element 69 towards the housing cylinder 42 to bring the idler wheels 67 into contact with the side wall of the container 1.

FIG. 9 illustrates the upper occluders 70 removed from said end stroke position. In addition, FIG. 9 shows a gear 64 and a worm screw 65 that define the kinematic coupling between the drive wheel 59 and the corresponding actuator 62.

The operation of the system for producing a radioisotope 34 is described hereinafter with particular reference to FIGS. 6 and 10-13.

Initially, the angular orientation station 41 is located in the end stroke position (FIG. 8) with the occluder elements 70, and the handling assembly 45 is located with the gripping head 46 coaxially raised above the housing cylinder 42 (FIG. 6). The pneumatic transfer system exerts a positive pressure towards the conduit 38 to transfer the container 1 oriented with the opening of the access conduit 31 towards the gripping head 46 to the housing cylinder 42 of the angular orientation station 41 (FIG. 6). The container 1 stops on the occluder elements 70. FIG. 6 illustrates the not correctly oriented container 1 and the elliptical shape of the section S of the proton beam B.

At this point, the actuators 60 and 68 of the rotation assembly 43 translate the shafts of the drive wheel 59 and idler wheels 67 towards the housing cylinder 42 so that all the wheels engage the corresponding slots 58 and 66 until they come into contact with the side wall of the container 1 and the occluder elements 73 project into the housing cylinder 42.

The actuators 71 are activated to distance the occluders 70 from the end stroke position so as to free the container 1 above; the container remains in the position reached since held by the pressure of the idler wheels 67 and drive wheel 59.

The rotation assembly 43 and the handling assembly 45 are activated to cooperate between them so as to correctly orient the container 1. In particular, the actuator 62 rotates the drive wheel 59 to rotate the container 1 in the housing cylinder 42 and, at the same time, the actuator 54 of the handling assembly 45 moves the gripping head 46 towards the housing cylinder 42 to engage the access conduit 31 of the container 1 with the centring element 56. When the shape coupling occurs between the centring element 56 and the access conduit 31, it means that the container 1 is correctly oriented, i.e. the elliptical shape of the portion of solid target material M is oriented like the elliptical shape of the section S of the proton beam B.

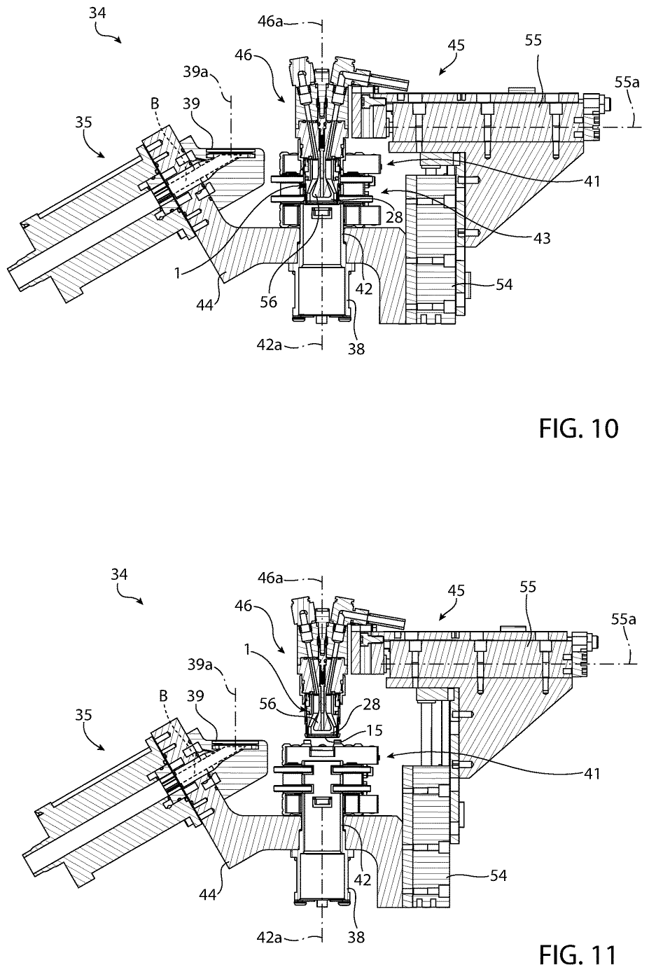

Having achieved the correct orientation, the actuator 62 detects opposition torque and stops, and the gripping head 46 continues its path until the coupling portion 47 hermetically closes the access conduit 31 and, thus, the centring element 56 completely enters the cavity 28 of the container 1 (FIG. 10).

At this point, the conduits 51 of the coupling portion 47 are connected to the vacuum generator 48 to suck air from the cavity 28 so that the gripping head 46 grasps and holds the container 1.

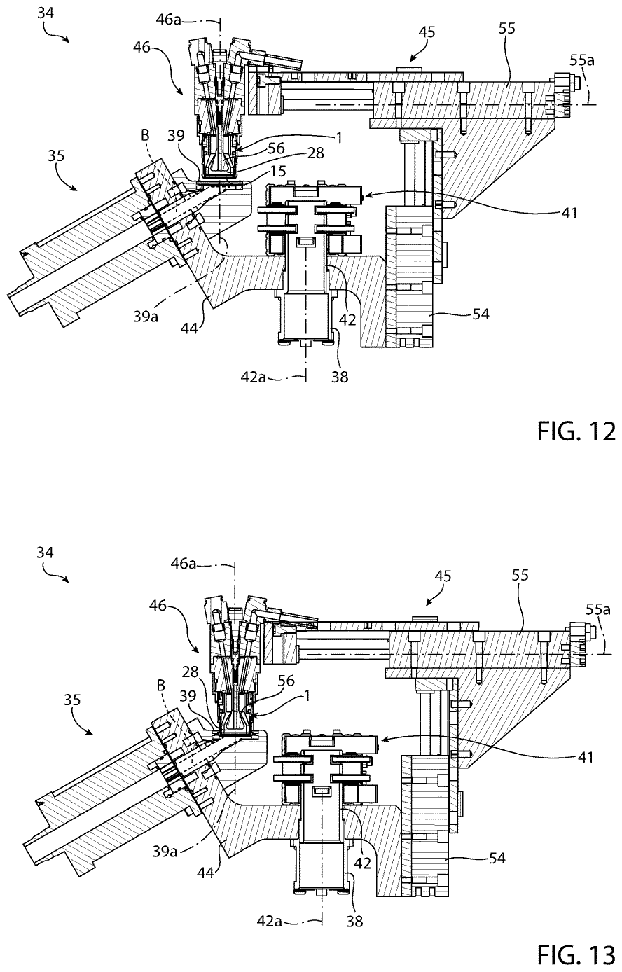

The handling assembly 45 is activated to remove the gripping head 46 from the housing cylinder 42 via the actuator 54 (FIG. 11), to move the gripping head 46 from the angular orientation station 41 to the irradiation station 35 in a position coaxial to the annular seat 39, via the actuator 55 (FIG. 12), and, finally, to draw the gripping head 46 closer to the annular seat 39, via the actuator 54, to couple the bottom 15 of the cup cap 6 of the container 1 to the annular seat 39 and hold the container 1 in that position for the entire duration of the irradiation of the portion of solid target material M (FIG. 13).

When the container 1 is positioned in the irradiation station 35 during the irradiation of the solid target material M, the conduits 51 of the coupling portion 47 are connected to the liquid cooling system 52 to make a cooling liquid circulate in the cavity 28. In this situation, the centring element 56 acts as a fluid deviator since it has a first portion 56a (FIG. 7) shaped so as to divide the access conduit 31 into an inlet and an outlet for the cooling fluid and a second portion 56b (FIG. 7) shaped to define, in the cavity 28, a circulation channel for the cooling fluid that extends between the inlet and the outlet that is basically U-shaped (FIG. 13).

At the end of the irradiation of the solid target material M, the handling assembly 45 is activated in the opposite way to bring the container 1 into the housing cylinder 42, from where the pneumatic transfer system withdraws the container 1 to transfer it to the dissolving station, exercising a negative pressure towards the conduit 38.

The actuators 54, 55, 60, 62, 69, and 71, vacuum generator 48, and the liquid cooling system 52 are controlled by a control unit configured to implement the operation steps described above.

Although the invention described above makes particular reference to a very specific embodiment, it is not to be considered limited to that embodiment, since it encompasses all those variants, modifications, or simplifications covered by the attached claims, such as, for example: a single idler wheel 67 or a single pair of coaxial idler wheels 67 arranged with their shaft in a diametrically opposite position, in relation to the axis 42a, to the shaft of the drive wheel 59.

The main advantage of the system for producing a radioisotope 34 described above is maximising the production of radioisotopes with the same proton beam section, the same proton beam energy, and the same thickness of the solid target material.

1. A system for the production of a radioisotope comprising:
a container for a portion of solid target material,
an irradiation station comprising a cyclotron for emitting a proton beam against the portion of solid target material in the container, and
a transfer system for transferring the container to the irradiation station;
the container extends along a longitudinal axis and comprises a cylindrical support body having a first longitudinal end defined by a planar face on which the portion of solid target material is present and has an elliptical shape;
the irradiation station comprises an annular seat, which is suitable for coaxially receiving the container from the side of the planar face, has an opening communicating with the cyclotron and is oriented according to a first axis oblique to the proton beam in such a way that a section of the proton beam along a virtual plane of the annular seat is elliptical;
the transfer system comprises an angular orientation station, which comprises a housing cylinder for coaxially housing the container and a rotation assembly for rotating the container within the housing cylinder in order to orient the elliptical shape of the solid target material portion as the elliptical shape of said proton beam section, and a handling assembly for grasping the container from the side opposite the planar face and transferring it from the angular orientation station to the irradiation station, in particular from the housing cylinder to the annular seat.

2. The system according to claim 1, wherein said housing cylinder comprises at least a lateral first slot and said rotation assembly comprises a drive wheel, a first actuator for engaging the drive wheel in the first slot until it touches a side wall of the container, and a second actuator for driving the drive wheel in order to rotate the container inside the housing cylinder.

3. The system according to claim 2, wherein said housing cylinder comprises at least a lateral second slot and said rotation assembly comprises at least one idler wheel and a third actuator for engaging the idler wheel in the second slot until it touches a side wall of the container so as to facilitate rotation of the container in the housing cylinder.

4. The system according to claim 1, wherein the housing cylinder extends along a second axis, has a first end connectable to a pneumatic system for receiving the container and a second open end to allow the handling assembly to grasp the container; the angular orientation station comprising at least a first occluder element movable along a direction transverse to the second axis at the second end of the housing cylinder, and a fourth actuator for moving the first occluder element towards and from an end stroke position, wherein the container is intercepted at the second open end.

5. The system according to claim 2, wherein the housing cylinder comprises at least a lateral third slot and the angular orientation station comprises a second occluder element movable along said direction through the third slot; the rotation assembly comprises a support element, to which the shaft of the drive wheel is fixed and in which the second occluder element is formed, and said first actuator is adapted to translate the support element towards the housing cylinder for, in addition to bringing the drive wheel into contact with the side wall of the container, causing the second occluder element to protrude into the housing cylinder in order to prevent the container from quitting the first end.

6. The system according to claim 1, wherein said housing cylinder extends along a second axis parallel to the first axis.

7. The system according to claim 1, wherein said support body comprises a second longitudinal end, which is axially opposed to said first longitudinal end, and an inner cavity, which is accessible through an access conduit open at said second longitudinal end, said elliptical shape of said solid target material portion has a predetermined angular position with respect to a transverse shape of the access conduit, the housing cylinder extends along a second axis and the handling assembly comprises a gripping head, which is movable parallel to the second axis and has a centring element capable of engaging without interference the access conduit with an at least partial transverse shape coupling such that the gripping head cooperates with the rotation assembly to properly orient the container.

8. The system according to claim 7, wherein the centring element comprises an outer transverse shape such as to achieve an at least partially shaped coupling with the transverse shape of the access conduit; the outer transverse shape having a predetermined angular position with respect to the elliptical shape of said section of the proton beam, in particular corresponding to the angular position of the elliptical shape of the solid target material portion with respect to the transverse shape of the access conduit.

9. The system according to claim 1, wherein said support body comprises a second longitudinal end, which is axially opposed to the first longitudinal end, and an inner cavity, which is accessible via an access conduit open at the second longitudinal end, and the handling assembly comprises a gripping head, which comprises a coupling portion for hermetically sealing the access conduit, and a vacuum generator connected to the coupling portion for sucking air from the cavity so that the gripping head can hold the container.

10. The system according to claim 1, wherein said support body comprises a second longitudinal end axially opposed to the first longitudinal end, said housing cylinder extends along a second axis and said handling assembly comprises a gripping head for gripping the container at the second longitudinal end, a movable support which is movable parallel to the second axis and on which the gripping head is mounted, a fifth actuator for moving the movable support with respect to the housing cylinder parallel to the second axis, a sixth actuator mounted on the movable support for moving the gripping head relative to the movable support along a third axis orthogonal to the second axis, between the angular orientation station and the irradiation station.

11. The system according to claim 1, wherein the container comprises a cup cap, which is fitted on the support body on the side of the planar face and comprises a bottom traversable by the proton beam and defining, together with the planar face, a cavity for containing the solid target material portion; the annular seat being designed to receive the cup cap from the side of the bottom; the handling assembly being designed to grasp the container from the side opposite to that of the bottom.

12. The system according to claim 2, wherein the container comprises a cup cap, which is fitted on the support body from the side of the planar face and whose side wall defines the side wall of the container.
